(19) United States
(12) Patent Application Publication
(10) Pub. No.: US 2023/0004996 A1
(43) Pub. Date: Jan. 5, 2023

(54) METHOD AND APPARATUS FOR CONFIGURED INFORMATION DELIVERY

(71) Applicant: Oi Digital Ltd., Cheltenham (GB)

(72) Inventor: David Ashley, Cheltenham (GB)

(73) Assignee: Oi Digital Ltd., Cheltenham (GB)

(21) Appl. No.: 17/857,250

(22) Filed: Jul. 5, 2022

(30) Foreign Application Priority Data
Jul. 5, 2021 (GB) 2109671.4

(51) Int. Cl. G06Q 30/02

(52) U.S. Cl. CPC G06Q 30/0203

(57) ABSTRACT

A computer-implemented method of constructing a customized information delivery system for a content owner to deliver information to recipients comprising constructing a directory of information assets for delivery to recipients. Profile characteristics and profile characteristic values for developing profiles of information recipients are determined, as are a set of content themes. The information assets are associated with the content themes. For at least some of the information assets, a delivery priority or a relevance to a profile characteristic value, or both, are provided. Actions for determining profile characteristic values from a recipient are determined, whereby an action may be presented to a recipient on delivery of an information asset to the recipient. An action may be provided to the recipient to determine profile characteristic values of the recipient—the responses can be used to form a modified profile for providing further information assets to the recipient.

### FIELD OF THE INVENTION

This invention relates to a method and apparatus for configured information delivery. It is particularly relevant to the provision of a structured information delivery system to individuals personalized according to developed awareness of the knowledge and needs of those individuals.

### BACKGROUND

Content owners and content providers will typically have very extensive resources of content to provide to consumers of the content, and some mechanism will usually be needed to provide content to these consumers in a structured fashion. In the case of a library of content, this will typically use a recommendation system in which consumer preferences are determined from former content choices, possibly supplemented by questions answered on initial registration, and recommendations are made on the basis of these consumer preferences.

Different issues arise where the purpose of the content provision is to educate or influence the consumer rather than simply to provide them with content that they will like. In this case, there may be a specific goal associated with the content provision process, and it would be desirable for the content provision process to achieve that goal. One such environment would be in the provision of educational courses to consumers, where an objective may be to ensure that consumers were exposed to a set of required teaching points.

One particularly demanding problem is the construction of marketing campaigns, particularly those in which education of consumers as to the nature of the product and its use is critical to the marketing process. The marketing of pharmaceuticals and other medical products is typical of this—there a variety of consumers for such marketing (healthcare professionals and administrators of different types), they require different knowledge to determine whether or not they wish to use or purchase the product, or to persuade others to use it, and in consequence different content may be appropriate for different consumers, or for the same consumer at different times. Multiple channels are typically available for communicating with such consumers, and there are different interaction mechanisms available over different channels.

The product owner and their marketing partner will typically work together to provide a structured content delivery offering which provides appropriate content to consumers at appropriate times—however, this is essentially a manual process, as it has not been apparent how this process could readily be automated. There are some electronic campaign planning tools that can be used to assist this process, such as Journey Builder in Salesforce, but these require extensive manual configuration and full definition of user journeys. It would be desirable for a product owner to be able to provide their content to consumers in a way that is configured to the current knowledge and needs of individual users in order best to meet the goal of the product owner.

It is against this background that the present invention has been devised.

### SUMMARY OF THE INVENTION

In a first aspect, the invention provides a computer-implemented method of constructing a customized information delivery system for a content owner to deliver information to recipients, comprising: constructing a directory of information assets available for delivery to recipients; determining profile characteristics and associated profile characteristic values for developing profiles of information recipients; determining a set of content themes, and associating the information assets in the directory with the content themes; providing for at least some of the information assets, a delivery priority or a relevance to a profile characteristic value, or both; determining a plurality of actions for determining profile characteristic values from a recipient, whereby an action may be presented to a recipient on delivery of an information asset to the recipient.

This approach allows a flexible user journey through information to be developed based on the information needed by a recipient—it enables different paths to be developed for different recipients, rather than requiring them to move through a predetermined user journey. It also avoids the need for definition—typically by an expert user—of each step of the journey, as the prior art typically requires.

In embodiments, each of the plurality of actions is associated with at least one information asset. An action may be configured to obtain a plurality of profile characteristic values. An action may also have an associated communication type. This may be, for example, one of the following: chatbot, survey, or poll.

One or more themes may be associated with a messaging hierarchy, with the information assets to be provided in the messaging hierarchy differing according to profile characteristic value. One or more of the profile characteristic values may have an associated sequence of provision of information assets. One or more of the profile characteristic values may also have an associated content theme, or an associated sub-theme in a content theme hierarchy. A strategic view for illustration of the content theme hierarchy may also be provided—this may be helpful for supporting users in planning the customized information delivery system.

In embodiments, this customized information delivery system may provide a structured marketing campaign. This may for example be associated with one or more pharmaceutical products, wherein the information assets provide information relating to the use of the pharmaceutical products or to diseases treatable by the pharmaceutical products.

In a second aspect, the invention provides a computer-implemented method for delivering information to recipients using a customized information delivery system, the method comprising: constructing a customized information delivery system according to the method of the first aspect; on delivery of one or more information assets to a recipient, providing an action to the recipient to determine profile characteristic values of the recipient; on receipt of a response to the action, modifying or adding one or more profile characteristic values to the profile of the recipient to form a modified profile; and indicating or providing one or more further information assets to the recipient on the basis of the modified profile.

In providing an action, the choice of action to provide may be determined by profile characteristic values already obtained from the recipient. In some cases, the choice of action may be directed to at least one profile characteristic for which no profile characteristic values have been received for the recipient. In some cases, the choice of action may be directed to at least one profile characteristic for which a value has already been received for the recipient to determine whether there has been a change in profile characteristic value.

In embodiments an artificial intelligence agent may be provided for action choice, wherein the artificial intelligence agent determines which action to provide if multiple profile characteristic values are required from the recipient. In embodiments, an artificial intelligence agent may be provided for indicating or providing further information assets, where the modified profile is consistent with more than one choice of information asset for provision to the recipient, where said information asset or assets have not already been provided to the recipient.

In a third aspect, the invention provides a computing platform for establishing a customized information delivery system to deliver information to recipients, the computing platform comprising a processor and a memory, wherein the processor is programmed to perform the following functions: construction of a directory of information assets available for delivery to recipients; determination of profile characteristics and associated profile characteristic values for developing profiles of information recipients; determination of a set of content themes, and association of the information assets in the directory with the content themes; provision for at least some of the information assets, a delivery priority or a relevance to a profile characteristic value, or both; and determination of a plurality of actions for determining profile characteristic values from a recipient, whereby an action may be presented to a recipient on delivery of an information asset to the recipient.

The computing platform may further comprise an artificial intelligence agent for action choice, wherein the artificial intelligence agent is adapted to determine which action to provide if multiple profile characteristic values are required from the recipient.

The computing platform may further comprise an artificial intelligence agent adapted to indicate or provide further information assets, where the modified profile is consistent with more than one choice of information asset for provision to the recipient, wherein said information asset or assets have not already been provided to the recipient.

### BRIEF DESCRIPTION OF THE DRAWINGS

In order that the invention may be more readily understood, preferred non-limiting embodiments thereof will now be described, by way of example only, with reference to the accompanying drawings, in which:

FIG. 1 illustrates a context for which embodiments of the invention are particularly appropriate;

FIG. 2 shows schematically elements of a system according to an embodiment of the invention;

FIG. 3 shows an exemplary screen for adding an insight in the profiling module of FIG. 2;

FIG. 4 shows an exemplary main screen for the profiling module of FIG. 2;

FIG. 5 shows an exemplary screen for adding details for a new insight value in the profiling module of FIG. 2;

FIG. 6 shows an exemplary main screen for the theme building module of FIG. 2;

FIG. 7 shows a main screen of the sequencing module of FIG. 2 illustrating priority sequencing;

FIG. 8 shows a main screen of the sequencing module of FIG. 2 illustrating content clustering;

FIG. 9 shows a main screen of the simulator module of FIG. 2;

FIG. 10 shows a main screen of the action configuration module of FIG. 2;

FIG. 11 shows a screen for adding an action in the action configuration module;

FIG. 12 shows a screen for providing questions and answer values for an action;

FIG. 13 shows a screen for displaying and potentially reordering questions in an action;

FIG. 14 shows an action set up screen for associating actions with content; and

FIG. 15 shows an interface to enable action sequencing.

### SPECIFIC DESCRIPTION

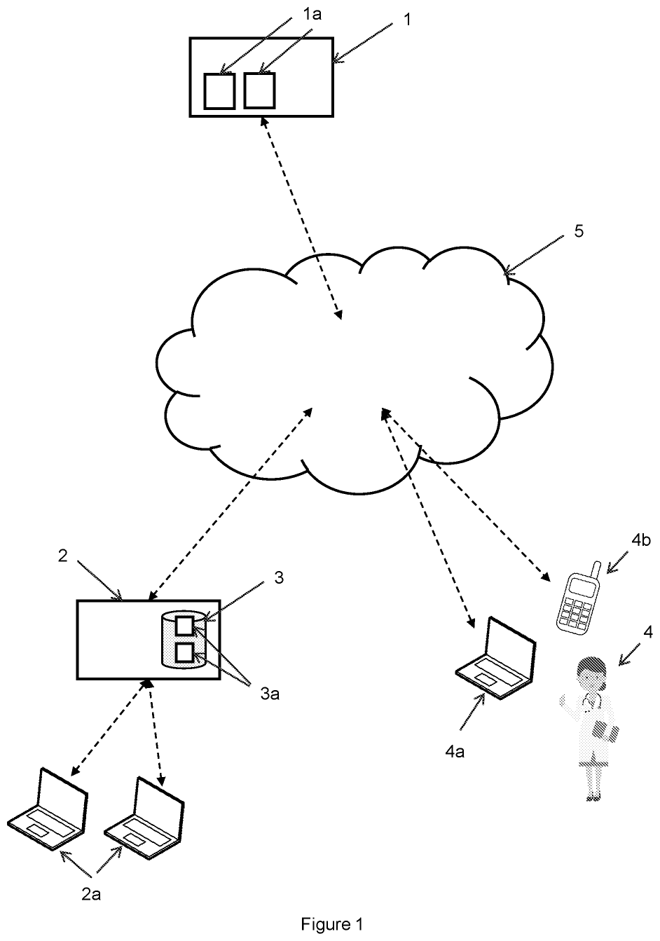

FIG. 1 shows an infrastructure in which embodiments of the invention may be employed. A service provider 1 provides a content delivery configuration platform—in this case, provided through a server or network of servers 1a over the cloud (represented by the public internet 5 as a mechanism for making connections between parties)—which content providers 2 and their personnel 2a can determine how content items 3a from their library of content 3 may be provided to consumers 4 in a structured way. The consumers 4 may be reached through multiple devices—for example, by personal computer 4a, by mobile phone 4b, or by other communication means—and by multiple channels over those devices, such as e-mail, web content, and social media.

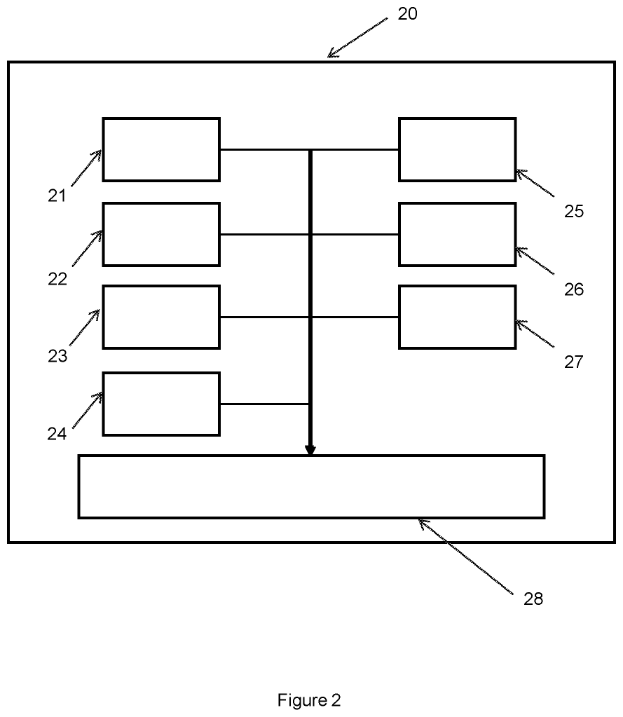

FIG. 2 provides an embodiment of a content delivery configuration platform 20 hosted by the service provider 1 of FIG. 1. The platform provides a series of modules with which the content provider 2 can interact to configure a content delivery structure, such as a marketing campaign for a specific pharmaceutical product. Construction and performance of such a marketing campaign will be taken as the working example of a content delivery structure for the example described in detail below, though the skilled person will appreciate that content delivery structures may be used for other purposes, such as providing structured learning about other topics.

The content provider can interact with these modules through the platform 20 to configure a marketing campaign, test the configured marketing campaign to determine whether it is ready for operation, to modify a campaign which is under way, and to obtain analytics on the campaign when it is under way or complete. The modules provided through the platform are a campaign set up module 21, a consumer profiling module 22, a theme building module 23, a sequencing module 24, a simulator 25, an action configuration module 26, and an analytics module 27—interaction with each module is through a main dashboard 28. These modules are each described in detail below. In the embodiment described, the platform 20 is made available to the content provider through the cloud—the content provider will typically be able to log into the platform 20 over the public internet or an appropriate network connection with an appropriate security protocol so that the content provider can establish a campaign, configure and test it fully, and analyze the campaign when under way, all using their own computer (or computers) as a client.

Campaign set up module 21 allows the content owner (also referred to below as client) to set up the basic parameters of the campaign and to establish integration with different technology platforms. One feature of campaign set up is to establish each content item—or digital asset—that may be provided to a consumer as part of a campaign. Typically content will be imported in a way that not only identifies the digital asset (either provides it directly, or provides a link to where it may be obtained), but also provides relevant metadata to allow the digital asset to be managed effectively. Suitable metadata may be $asset_title, $asset_description, $asset_author, $asset_format etc. A typical example of this could be the metadata for a website that includes details of the title of each of the pages in the website, the author of the content and a description of the content of the page.

To provide content orchestration and automation functionality, the content delivery system needs to be integrated with the technology platforms utilised by the client for their campaign. Exemplary technologies include (but are not restricted to); data analytics platforms, website content management systems, content management platforms, consumer relationship management programs etc.). These technology platforms are integrated by API with the content delivery platform, with details of integrated technology platforms displayed in a campaign set-up dashboard. Once the digital assets have been identified and delivery systems determined, the campaign can be configured. This will be described in a module-by-module manner, though it will be appreciated that the different modules can be used at different times by different stakeholders (such as for example brand managers, IT managers, CRM managers, regulatory managers, digital content managers etc.) either together or separately.

Consumer profiling module 22 allows the client to establish the criteria of a consumer profile. These criteria establish key characteristics of target consumers for the campaign. They establish information that needs to be learned about the consumer to determine what digital assets should be provided to the consumer, and in some cases represent characteristics that may change over time (for example, with the level of a consumer's familiarity with or acceptance of a product) and may therefore change what digital assets the consumer may need. Consumer profiling is here established by variables referred to as “insights”.

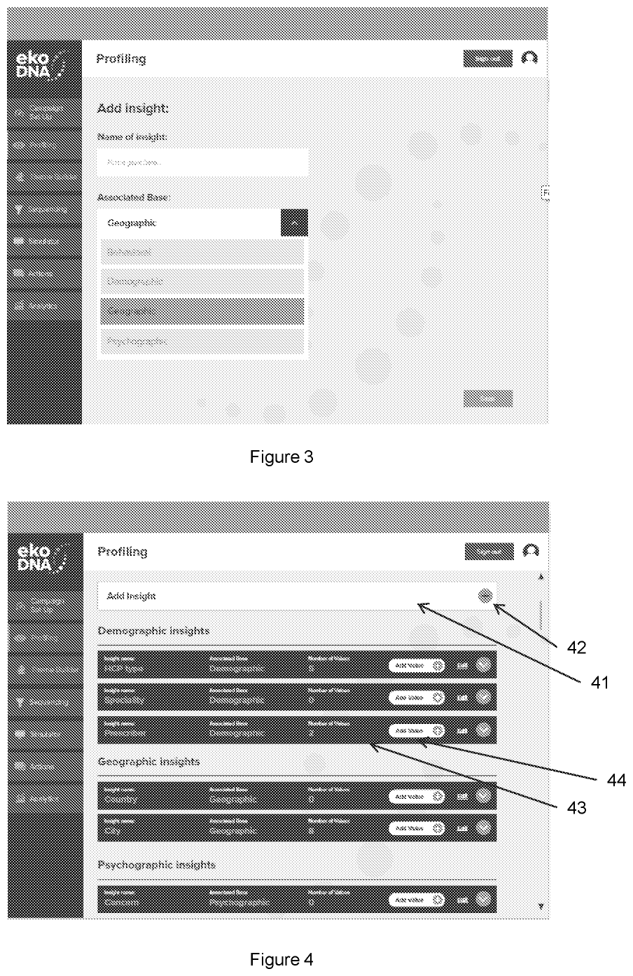

In this example, as shown in FIG. 3 which illustrates a screen for adding a new insight, there are four different ways in which consumers can be segmented. These segmentation bases are behavioral (such as whether the consumer uses the product in certain situations, or is an advocate for the product), demographic (for example the functional role of the consumer, such as “healthcare professional”, or their healthcare specialty), geographic (for example country or language of the consumer) and psychographic (such as the attitude of the consumer to the product, or concerns or level of influence of the consumer).

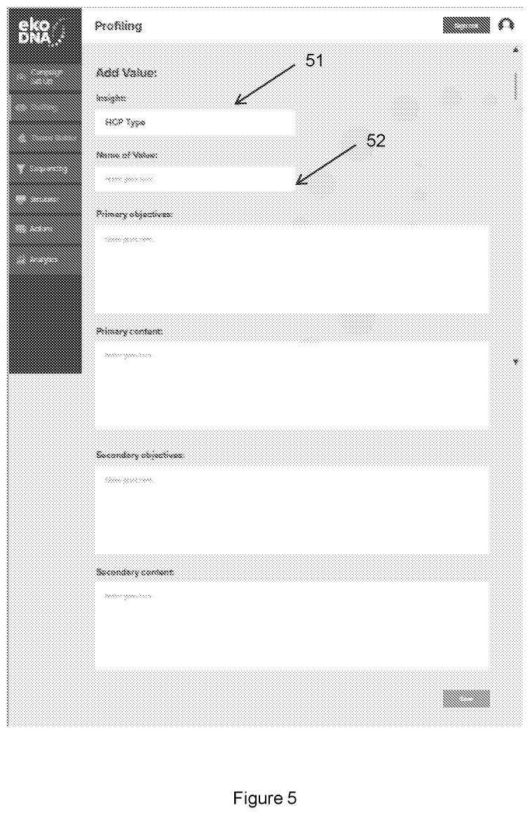

FIG. 4 shows a main screen for the profiling module with insights partially established. As for all the modules described below, the main screen provides a dashboard for viewing existing material and adding new material. A new insight can be established by clicking the ‘+’ symbol 42 on the ‘Add Insight’ button 41. As indicated on FIG. 3, the insight then needs to be named and its segmentation base established. Each insight needs to have at least two values associated with it: for example, the demographic insight ‘healthcare professional type’ may have the values ‘doctor’ and ‘nurse’ only, whereas the geographic insight ‘country’ may have any of the countries of the world. To set a value for an insight the client selects the ‘Add Value’ button 44 for an insight listing 43 from the main Profiling screen, as shown in FIG. 4. FIG. 5 illustrates the information that then needs to be entered for the new value of the insight 51—the main one of which is a name 52 for the value. The client may at this point select topics, core messages and claims that they consider may be particularly appropriate for users with this insight value. Advantageously, guidance notes may also be provided here as to what primary and secondary objectives are for consumers with this value, and as to what primary and secondary content recommendations should be for consumers with this value. This information is for the client's information and is not used directly in the orchestration and automation processes triggered by the system. However, providing this information at this point in the system is advantageous as typically there will be a number of different client users with different roles—this allows consensus to be built as to the approach to be taken in presenting digital assets to particular types of consumer. This information may be used by the client in the sequencing module 24 discussed further below.

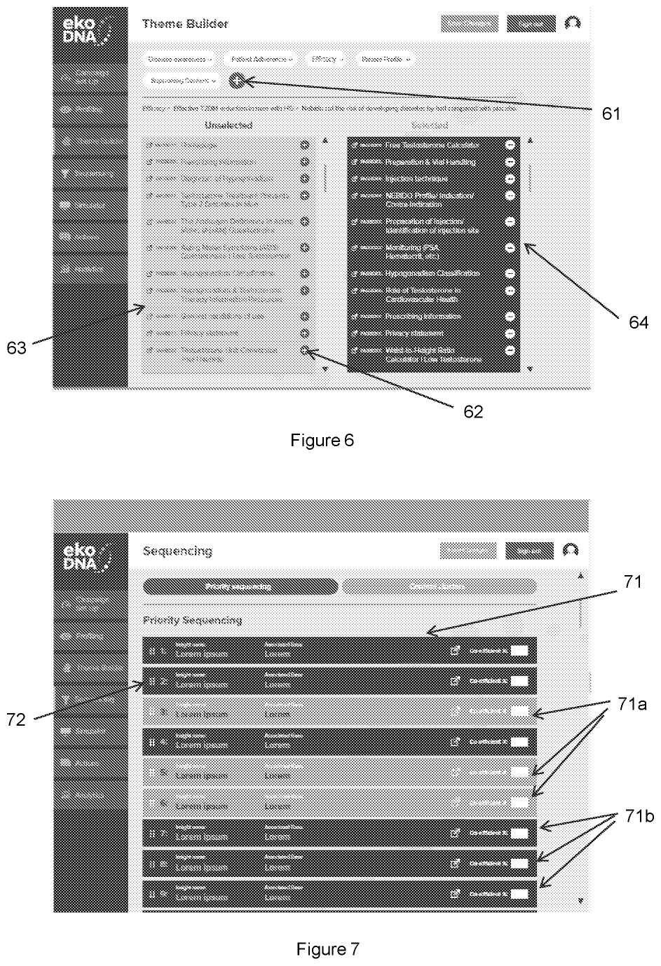

The purpose of the theme building module 23 is to cluster digital assets forming the campaign content into themes, which will then be used in determination of how and when digital assets will be provided to consumers. FIG. 6 shows an exemplary main screen for the theme building module. The client can create a new theme by clicking the ‘+’ (add theme) symbol 61 at the top of the dashboard. In the exemplary approach shown here, there is a three-level hierarchy associated with each theme. The top level indicates specific topics—examples such as “Disease Awareness” and “Efficacy” are shown in FIG. 6, and below these topic-themes there are child-theme and sub-theme levels. A child-theme here represents a core message associated with the campaign (such as the long-term efficacy of the product, as a child-theme of “Efficacy”), and the sub-theme represents a specific claim associated with that core message (for example, that long term efficacy of the product is demonstrated by a reduced risk of death from the disease treated by the product).

Typically, these themes will be aligned to the message hierarchy associated with the product/brand being promoted and the client will ensure common themes are applied to campaign materials imported into the content delivery system. If a client already has a defined message hierarchy in an existing content management platform, then it may be possible to import such data to automatically create the campaign themes in the campaign set-up process. Such a message hierarchy may already have associated content—this may be tagged with a theme, in which case this can be used to populate themes directly (though any content not so tagged would need to be manually clustered).

Whether or not the message hierarchy is newly constructed or imported, it will still now be necessary to cluster the digital assets comprising the campaign content for each of the themes. The client can cluster content from the imported campaign materials for each of the themes and their associated child-themes and further sub-themes. To do this they would simply select the ‘+’ symbol button 62 on the required content items from the Unselected content list 63 as shown in FIG. 6 after identifying a particular theme. This would add the content item to the content cluster for the theme, adding them to the Selected content list 64 for that theme.

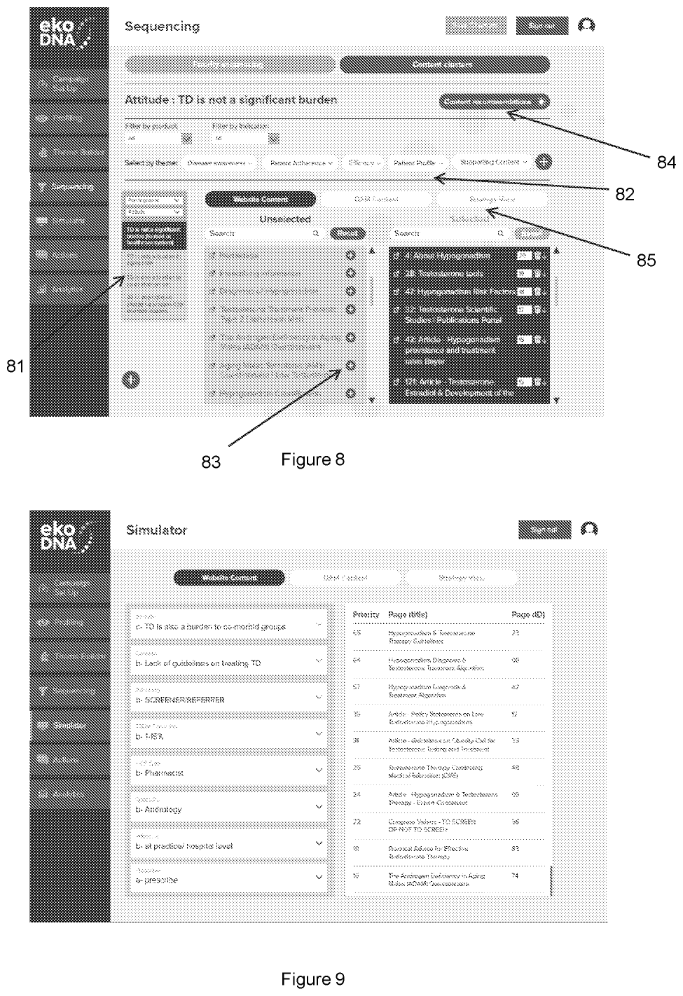

The campaign is defined by the campaign set up module 21, consumer profile characteristics are established by the consumer profiling module 22, and digital content is associated with themes of the campaign in the theme building module 23. This campaign information can now be used to determine which content is provided to consumers for what purposes. This is determined by the next module, the sequencing module 24, which determines the order in which content is recommended to the consumer. The sequencing module main screens are shown in FIGS. 7 and 8. Two screens are shown, as in the example shown two different sequencing strategies are used.

FIG. 7 illustrates the first sequencing strategy, priority sequencing. This involves the sequencing of insights in priority order—co-efficient value is associated with each insight to indicate the level of priority the AI engine should assign to the insight when processing associated content recommendations. FIG. 7 shows a list of the insights that the client has set-up for the campaign. To adjust the sequence the client can simply drag the insights 71 into the order of priority in the list by clicking on the insight listing 71. Here, listings are divided into two types: listings 71a in one colour to indicate when a content cluster has been associated with the insight, and listings 71b in another colour to indicate when no content cluster has been associated with the insight. The user can click the arrow icon on the listing to go to the specific content cluster settings for the insight.

FIG. 8 illustrates the second sequencing strategy, content clustering. Content clustering enables the client to select the segmentation base>insight>value from the sub-menu 81 on the left of the dashboard, and to then create a content cluster for the value. To do this, the client can simply select topic-themes, child-themes or sub-themes by clicking the pill shaped buttons 82 above the content lists. Selecting topic-themes or their child-/sub-themes) adds the pages from the associated theme content cluster to the Selected list for the insight value. In addition, the client can select individual pages from the Unselected list of content items by clicking the ‘+’ symbol button 83 next to the content listing.

At any stage, the client can click the ‘content recommendations’ button 84 above the list to review their original notes they added when setting up the selected value. An exemplary mechanism for ordering within a cluster is for content items in the Selected content cluster list to be automatically scored from 20 down to 5 in descending sequential order, with any content items listed below the first item scored 5 also automatically assigned a score of 5. Where such an automated mechanism is used, it can be varied—the client may also manually enter a score for a content item, and it will then automatically be re-positioned in the list based on its score. It may also be possible to add scores outside the range used in automatic scoring by manual assignment—for example, it may be possible to assign scores above 20 if required, but only manually.

A number of different views 85 may be made available at this point. The “Website Content” and “DAM Content” views provide clustered content for selection and other content associated with the value. By contrast, the “Strategy View” provides a sequential list of themes (topics), child themes (core messages) and sub-themes (claims) associated with the content selected for each of the insight values. This provides a simple view of the content theme hierarchy that is particularly helpful for sharing information with stakeholders not actively involved in construction of the customized information delivery system, for example for sharing the overall strategy and the core objectives for the system.

The combination of profiling, themes and sequencing provides the basis for content recommendation—an exemplary content recommendation mechanism will be described further below after discussion of the remaining modules.

FIG. 9 shows a main screen for a simulator module. The simulator dashboard enables the client to test the content recommendations that the content recommendation engine would make based on a range of insight values. During the testing process, the client can select a variety of ranges of insight values from the pre-populated list of insights and associated values. The list and sequence of content recommendations will then appear in the list on the right of the screen. This enables the client to input insight values from a wide range of consumer personas to evaluate the likely content recommendations. Values do not need to be selected for all insights for the simulator to start displaying content recommendations, as it will start display these as soon as the first value has been selected and will dynamically update the list of recommendations as additional values are selected.

If the client believes that the content recommendations are not fully aligned to their expectations (either sequentially or thematically) then they can make changes in order to adjust the recommendations, for example:
Adjust the sequence of insights in the sequencing>priority sequencing list
Adjust the co-efficient value associated with an insight in the sequencing>priority sequencing list
Adjust the sequence of the content associated with insight values in the sequencing>content clusters list
Delete content associated with insight values in the sequencing>content clusters list
Add content associated with insight values in the sequencing>content clusters list
Adjust the scores of the content associated with insight values in the sequencing>content clusters list

There is again a Strategy View available from this screen. This provides a sequential list of themes (topics), child themes (core messages) and sub-themes (claims) associated with the recommended content. This is particularly helpful to determine that core objectives are being satisfied by the content delivery system.

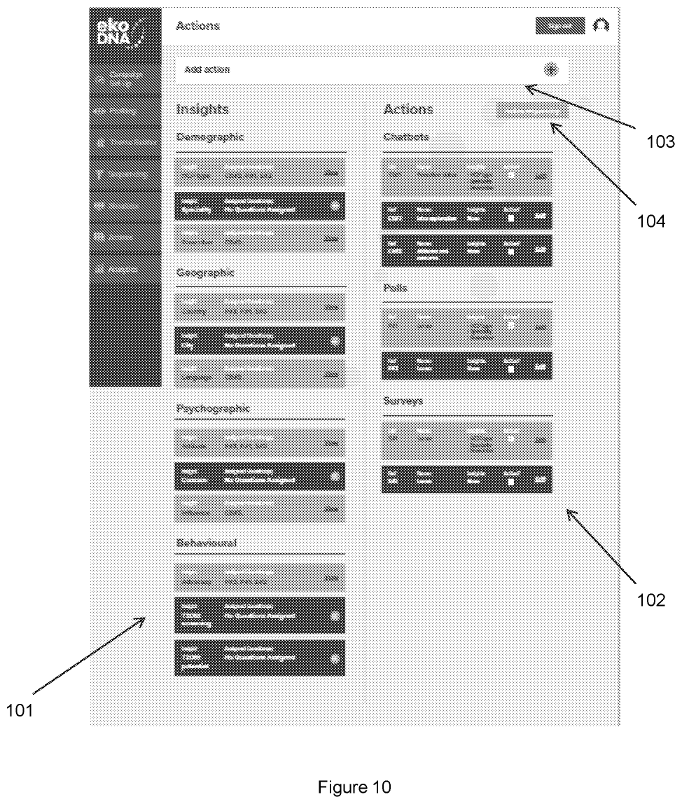

A main screen for the action configuration module is shown in FIG. 10. The actions dashboard enables the client to set up interventions to gain information from consumers to establish their insight values and so allow the consumers to be profiled. Three different types of interaction strategy with consumers are used in this embodiment—Chatbot, Poll and Survey—though other interaction or communication types can also be used if these will be effective to enable the consumer to communicate information that will establish insight values. At least one action needs to be created for each insight—otherwise it would not be possible to gather all the insights for a full profile of a consumer—although multiple actions can be configured for a single insight if required.

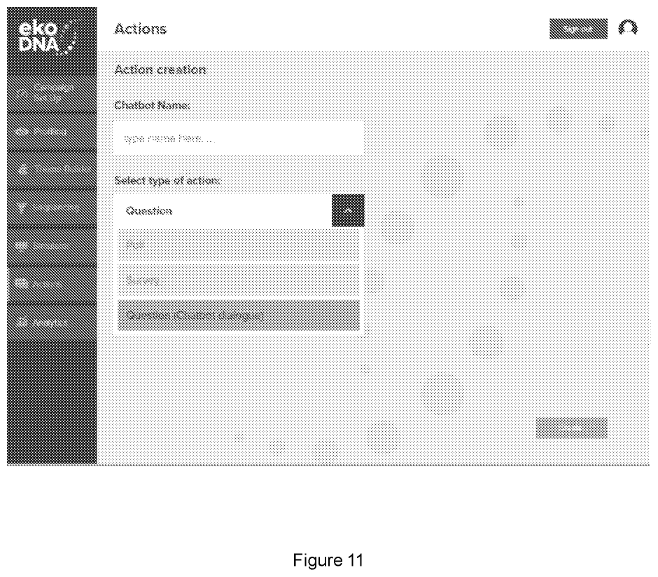

The initial actions dashboard screen displays a list of insights 101 and actions 102 grouped by segment and by action type respectively. Actions can be added through the ‘Add Action’ button 103 and the actions sequenced through the ‘Action Sequencing’ tab 104. The client creates a new action by clicking the ‘Add Action’ button 103 at the top of the dashboard. They can then name the action and select whether it will be a ChatBot, Poll or Survey format, as is shown in FIG. 11. Optional filters required to trigger the action may be selected at this point—these may include the following:
Consumer has that insight value (may be multiple insight values added)
Specific content viewed (may be multiple content items added)
Content recommendations viewed (for specific insight values)
Delay (since a previous interaction, either in time or intervening views)
Notification (may be triggered by an e-mail to the consumer).

Where such filters are used, all the conditions defined in the filters used must be satisfied for the action to be triggered.

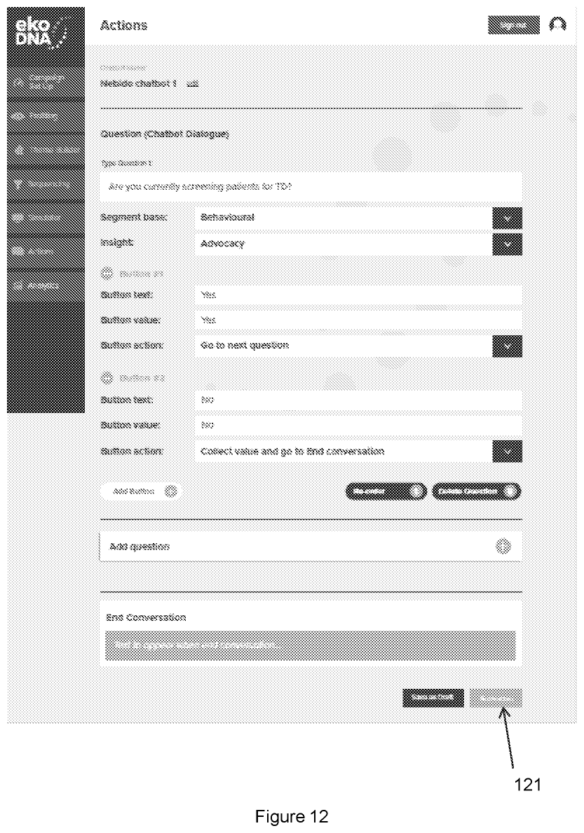

The client will then enter the first insight question that will be presented to users, selecting the segmentation base and associated insight for the question. Once selected, they would then enter the optional value options that can be presented to the user, as shown in FIG. 12.

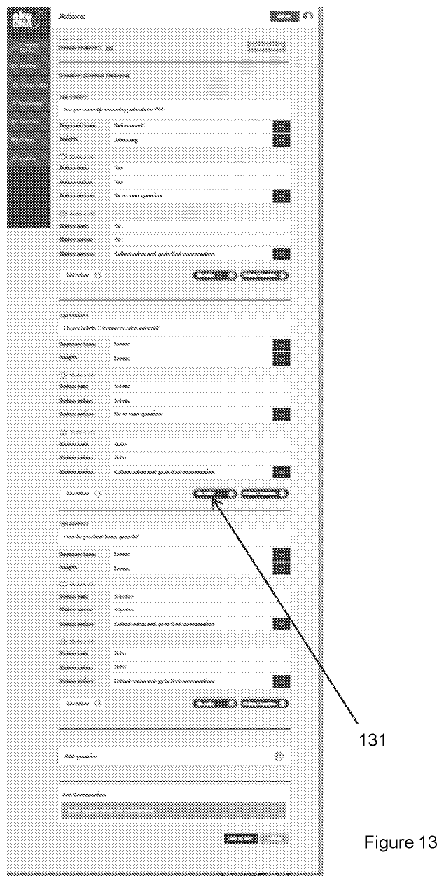

Actions are not directly associated with an insight—it is the questions within the action that are associated with insights. In practice, an action may include multiple questions on several insights. For example, several questions may be included in a ChatBot or Survey action. These questions can be re-ordered sequentially by clicking the re-order button 131 as is shown in FIG. 13, which illustrates a full list of questions, and dragging the questions into the required sequence.

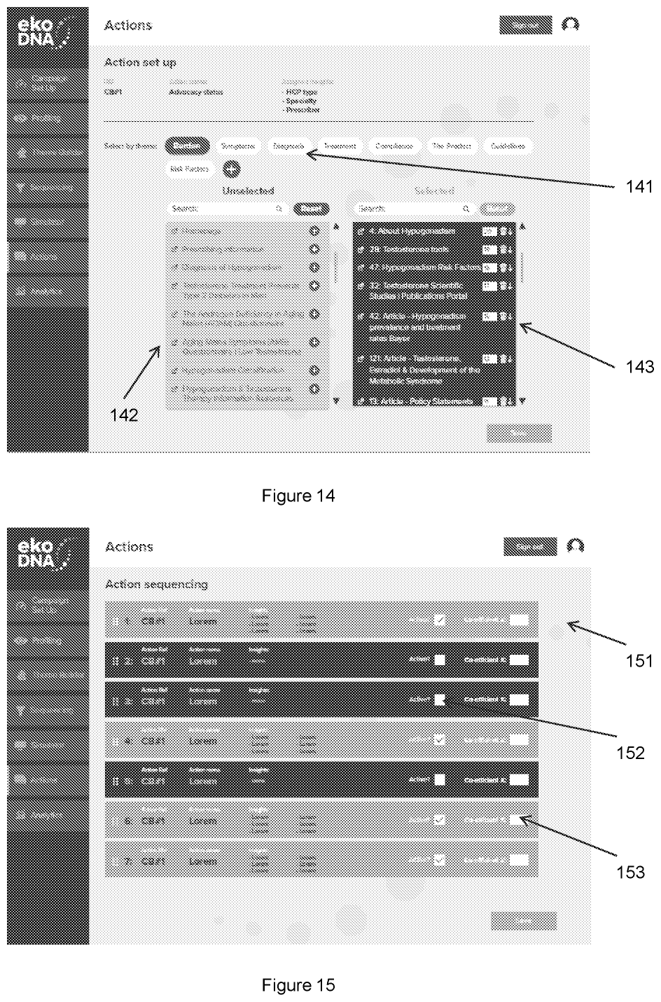

Clicking the ‘activation’ button 121 associated with an action (see FIG. 12) takes the client to the action set-up screen shown in FIG. 14, and this enables the client to associate content items with the action. This can be done either by selecting a theme 141, whereby any content items associated with the theme are then added to the Selected list 143, or by selecting individual content items from the Unselected list 142. The subsequent content cluster created here by the product owner provides guidance to the AI engine managing the interaction with the user on where to activate/trigger the actions—this is described further below.

Once the content cluster has been selected/activated for the action, the ‘activation’ button changes state to an ‘activation settings’ button—clicking this would bring the product owner back to the screen shown in FIG. 14 so they can edit any of the associated settings.

Typically, at least some of the content items will have multiple actions associated with them, so to help train the AI engine on which action to present to a user when they land on one of these content items, the ‘Action Sequencing’ tab is provided—this allows the client to adjust the priority sequence of the actions, as is shown in FIG. 15. The top listed action will have the highest priority, so if a user engages with a content item with two (or more) associated actions then the AI engine will understand which of these should be prioritized. The AI engine will also be aware of which insights have already been captured on a user and will take these into consideration. Consequently, the AI engine would not present an insight question in an action where the system has already captured the insight from the user unless the AI engine is trying to identify whether there has been any belief or behavioral change in the user regarding the insight since a previous interaction.

The ‘Active?’ checkbox 152 in the priority sequencing list of actions 151 (see FIG. 15) simply indicates whether or not the trigger content items have been associated with the action, so that the action will potentially be served if the content items are accessed. Optionally, a co-efficient 153 may be used for the priority sequencing of actions to allow a client to increase the likelihood of a particular action being presented to a user when they engage with content items with multiple associated actions.

Once an action has been configured (set-up), the client can preview an interactive version of the action to see how it would be presented to the consumer, and to test its functionality and logic. Optionally, the client may be able to download a report providing the specific details of all of the actions included in the campaign, displaying all of the dialogue/questions and options that are presented to the user. In the case of pharmaceutical marketing, this may be desirable to obtain regulatory approval.

The following approach may be used by the AI engine used to serve actions to the consumer:
Identify the actions associated with the content item the consumer is currently using
Identify the insights already established for that consumer.
Establish the priority sequence of the associated actions
Present the highest priority action if the system does not already have the insight value for the consumer.
If there are multiple questions in the action, then omit the questions where the insights have already been established.
If there is only one question in the action and the system already has captured the insight, then present the next action associated with the content item.

This approach is essentially mechanistic and may not itself require AI processing. More complexity is introduced if it is desired to determine whether the consumer's position has changed over time—certain aspects of the profile (demographic and geographic) will change rarely and may not change at all, whereas others (behavioral and particularly psychographic) may change significantly over time. In such cases the AI engine may present an action that contains an insight question where we already hold a value from a user in order to establish whether content they have engaged with has affected any belief or resulted in a behavioral change.

The analytics module 27 provides a dashboard (not shown) that enables the client to view data indicating engagement of consumers with content. Data can be filtered by any of the system parameters, including for example the following:
Date range
Segmentation base
Insight
Insight value
Content item
Content type
Themes (topics), child themes (core messages) and sub-themes (claims).
Time on page
Bounce rate.

In addition to standard engagement analytics, the client may also be able to drill further into the psychographic and behavioral data to establish the impact the content had on the beliefs and behaviors of customers (also using the same filters as above)—this may allow the client to establish which content is having the most impact for the different consumer types.

The provision of content recommendations to the consumer is preferably carried out by an AI engine—this may use any appropriate machine learning or other AI technology suitable to the context. As the choice of AI technology is not critical here and the parameters for determining how to make this choice will be known to the person skilled in the art, specific AI technology choices will not be discussed further here. General considerations will be discussed below, with a detailed strategy indicated below that.

Generally, such an AI content orchestration engine will be provided with guidelines as to how to sequence content recommendations, supplemented by training with feedback to guide the AI engine to make better choices. The following factors may be taken into account:
The insights currently associated with the consumer
The associated content clusters (e.g. a list of content items) for each of these insights.
The possibility that a content item will occur in more than one content cluster—this will often apply if there is more than one insight obtained for a consumer, as then there will typically be multiple content clusters.
Each content item has an associated score, and if it is in multiple content clusters associated with the user then each score may be added together
Each insight also has a co-efficient applied in the priority sequencing section—the content items total score may be multiplied by the associated co-efficient

Working within these parameters, a swarm intelligence behavioral algorithm may be applied to ensure that any content recommendations that are made only include content items that are directly related to the theme of the content item that is the active subject of the current consumer session (in other words, unrelated content items are filtered out of any recommendations).

A fully worked exemplary approach is set out below. This uses the following inputs: user profile, user recent page history (the last X pages), content hierarchy and associated content items, and content clusters (with associated coefficients, content items, and individual item priorities). The output will be a list of content items sequenced by primary priority score. The method has the following steps.

1—Retrieval of the cluster(s) of content matching the insights against the user record. An example may be as follows:
User record shows Belief A, and Behavior C, and retrieves the cluster coefficient and content (with priorities) matching those insights.
   Belief A, coefficient: 1.1: 15 items of content
      Content X: priority 20
      Content Y: priority 10
      Content Z: priority 8
      . . .
   Behaviour C, coefficient: 1.4: 6 items of content
      Content Z: priority 15
      Content X: priority 10
      . . .

2—For each content item featured in any of the matched insights, a weighting value is calculated for each content item taking into account the coefficient of the insight and the priority of each content item within each insight content cluster. An example may be as follows:
Content item X (X) is matched under both insights Belief A with priority 20 and a coefficient of 1.1 (A, content record association as AX) and Behaviour C with a priority of 10 and a coefficient of 1.4 (C, content record association as CX).
   X=Content item X
   A=Insight value: Belief A
   C=Insight value: Behaviour C
   AX=Content item X, as associated with Belief A
   CX=Content item X, as associated with Behaviour C
   X.priority_weight=(A.coefficient*AX.priority)+(C.coefficient*CX.priority)
   X.priority_weight=36=(1.1*20)+(1.4*10)

3—A list of all content themes is retrieved, and for each item, its priority score is added to a total score for that theme, and a sum total for all themes. An example may be as follows:
In this example, Content X belongs to themes 1, 2, and 5. Content Y belongs to themes 1 and 3, and Content Z belongs to themes 1, 3, and 5. Theme 4 contains no content matched from the previous steps.
   Theme #1: 53.6 (36 (Content X)+13.6 (Content Y)+4 (Content Z))
   Theme #2: 36 (36 (Content X))
   Theme #3: 17.6 (13.6 (Content Y)+4 (Content Z))
   Theme #4: 0
   Theme #5: 40 (36 (Content X)+4 (Content Z))
   Total: 147.2

4—Each theme's score is converted into a weight by dividing the score for each theme by the sum total. An example is as follows:
Theme×Weight=1+(Theme×Total/AllThemesSumTotal)
   Theme #1 Weight: 0.364 (53.6/147.2)
   Theme #2 Weight: 0.244 (36/147.2)
   Theme #3 Weight: 0.119 (17.6/147.2)
   Theme #4 Weight: 0
   Theme #5 Weight: 0.272 (40/147.2)

5—The theme weightings are applied to the individual page priorities. An example is as follows:
Content item X belongs to themes 1, 2, and 5, and Belief A and Behaviour C, as in previous examples.
   X=Content item X
   A=Insight value: Belief A
   C=Insight value: Behaviour C
   AX=Content item X, as associated with Belief A
   CX=Content item X, as associated with Behaviour C
   X.priority_weight=(A.coefficient*AX.priority)+(C.coefficient*CX.priority)
   X.theme_weight=Theme 1 weight+Theme 2 weight+Theme 5 weight
   - - -
   X.priority_weight=36 (following above examples)
   X.theme_weight=0.88=0.364+0.244+0.272
   X.association_weighted_priority=X.priority_weight*(1+X.theme_weight)
   X.association_weighted_priority=36*(1+0.88)
   X.association_weighted_priority=67.68

6—A list of the content items is compiled and sorted by weighted priority (descending). An example is as follows:
Content X—Weighted Priority: 67.68, Theme Association Weight: 0.88
Content Y—Weighted Priority: 52.19, Theme Association Weight: 0.635
Content Z—Weighted Priority: 43.6, Theme Association Weight: 0.516

7—Any items that the user has already seen within any sessions in the last n days are then removed from the list. An example may be as follows:
Content X: not yet seen
Content Y: viewed by the user 2 days ago, removed
Content Z: not yet seen

8—The weighted list of recommended items, along with the priority and theme association weightings, is then returned. An example is as follows:
#1. Content X—Weighted Priority: 67.68, Theme Association Weight: 0.88
#2. Content Z—Weighted Priority: 43.6, Theme Association Weight: 0.516
#3 . . . .

While the example set out in detail above relates to establishing of a marketing campaign for pharmaceutical marketing, the above approach can be applied to any structured learning hierarchy where there are associated learning goals. For example, the goal may be educational, but with different consumers of data items with different objectives—for example, driver education documents could be provided which allow different content to be served for the different needs of new drivers, drivers who need to requalify, drivers seeking higher driving qualifications and driving instructors. The skilled person will appreciate that there are a wide range of other possible contexts.

1. A computer-implemented method of constructing a customized information delivery system for a content owner to deliver information to recipients, comprising:
constructing a directory of information assets available for delivery to recipients;
determining profile characteristics and associated profile characteristic values for developing profiles of information recipients;
determining a set of content themes, and associating the information assets in the directory with the content themes;
providing for at least some of the information assets, a delivery priority or a relevance to a profile characteristic value, or both;
determining a plurality of actions for determining profile characteristic values from a recipient, whereby an action may be presented to a recipient on delivery of an information asset to the recipient.

2. The method of claim 1, wherein each of the plurality of actions is associated with at least one information asset.

3. The method of claim 1, wherein an action may be configured to obtain a plurality of profile characteristic values.

4. The method of claim 1, wherein each action has an associated communication type.

5. The method of claim 4, wherein the associated communication type for an action may be one of the following: chatbot, survey, or poll.

6. The method of claim 1, wherein one or more themes are associated with a messaging hierarchy, wherein the information assets to be provided in the messaging hierarchy differ according to profile characteristic value.

7. The method of claim 1, wherein one or more of the profile characteristic values has an associated sequence of provision of information assets.

8. The method of claim 1, wherein one or more of the profile characteristic values has an associated content theme, or an associated sub-theme in a content theme hierarchy.

9. The method of claim 8, wherein the method further comprises a strategic view for illustration of the content theme hierarchy.

10. The method of claim 1, wherein the customized information delivery system provides a structured marketing campaign.

11. The method of claim 10, wherein the structured marketing campaign is associated with one or more pharmaceutical products, and wherein the information assets provide information relating to the use of the pharmaceutical products or to diseases treatable by the pharmaceutical products.

12. A computer-implemented method for delivering information to recipients using a customized information delivery system, the method comprising:
constructing a customized information delivery system according to the method of claim 1;
on delivery of one or more information assets to a recipient, providing an action to the recipient to determine profile characteristic values of the recipient;
on receipt of a response to the action, modifying or adding one or more profile characteristic values to the profile of the recipient to form a modified profile; and
indicating or providing one or more further information assets to the recipient on the basis of the modified profile.

13. The method of claim 12, wherein in providing an action, the choice of action to provide is determined by profile characteristic values already obtained from the recipient.

14. The method of claim 13, wherein in providing an action, the choice of action is directed to at least one profile characteristic for which no profile characteristic values have been received for the recipient.

15. The method of claim 13, wherein in providing an action, the choice of action is directed to at least one profile characteristic for which a value has already been received for the recipient to determine whether there has been a change in profile characteristic value.

16. The method of claim 12, further comprising providing an artificial intelligence agent for action choice, wherein the artificial intelligence agent determines which action to provide if multiple profile characteristic values are required from the recipient.

17. The method of claim 12, further comprising providing an artificial intelligence agent for indicating or providing further information assets, where the modified profile is consistent with more than one choice of information asset for provision to the recipient, where said information asset or assets have not already been provided to the recipient.

18. A computing platform for establishing a customized information delivery system to deliver information to recipients, the computing platform comprising a processor and a memory, wherein the processor is programmed to perform the following functions:
construction of a directory of information assets available for delivery to recipients;
determination of profile characteristics and associated profile characteristic values for developing profiles of information recipients;
determination of a set of content themes, and association of the information assets in the directory with the content themes;
provision for at least some of the information assets, a delivery priority or a relevance to a profile characteristic value, or both; and
determination of a plurality of actions for determining profile characteristic values from a recipient, whereby an action may be presented to a recipient on delivery of an information asset to the recipient.

19. The computing platform of claim 18, further comprising an artificial intelligence agent for action choice, wherein the artificial intelligence agent is adapted to determine which action to provide if multiple profile characteristic values are required from the recipient.

20. The computing platform of claim 18, further comprising an artificial intelligence agent adapted to indicate or provide further information assets, where the modified profile is consistent with more than one choice of information asset for provision to the recipient, wherein said information asset or assets have not already been provided to the recipient.
